(19) United States
(12) Patent Application Publication
(10) Pub. No.: US 2026/0217165 A1
(43) Pub. Date: Jul. 30, 2026

(54) STORAGE STRUCTURE AND CHILD SAFETY SEAT

(71) Applicant: WONDERLAND SWITZERLAND AG, Steinhausen (CH)

(72) Inventors: Daliang ZHANG, Dongguan (CN); Guanghui ZHAO, Dongguan (CN); Ruyi LI, Dongguan (CN); Ganqing FANG, Dongguan (CN)

(21) Appl. No.: 19/148,285

(22) PCT Filed: Jan. 16, 2024
(86) PCT No.: PCT/EP2024/050938

§ 371 Date: Jul. 15, 2025

(30) Foreign Application Priority Data
Jan. 16, 2023 (CN) 2023100861160
May 30, 2023 (CN) 2023106308335
Jun. 21, 2023 (CN) 2023107486804

(51) Int. Cl. B60N 2/28

(52) U.S. Cl. CPC B60N 2/2812; B60N 2/2827

(57) ABSTRACT

The present disclosure relates to a child safety seat including a seat shell provided with a connecting through hole at an outer side of the seat shell; and a connecting assembly including a connecting strap and a plug. A first end of the connecting strap is limited after entering an internal space surrounded by an outer side of the seat shell through the connecting through hole, and a second end of the connecting strap is connected with the plug. The plug is configured to detachably connect with a receptacle of a vehicle seat. The present disclosure further provides a storage structure and a child safety seat using the storage structure. The storage structure is configured to store objects. The storage structure includes a shell. The shell is provided on a base of the child safety seat and forms a storage space for storing the objects.

### CROSS-REFERENCE TO RELATED APPLICATIONS

This application is a National Stage application of PCT/EP2024/050938, entitled “STORAGE STRUCTURE AND CHILD SAFETY SEAT” and filed on Jan. 16, 2024, which claims the benefits of Chinese Applications No. 202310086116.0, filed on Jan. 16, 2023, No. 202310630833.5, filed on May 30, 2023, and No. 202310748680.4, filed on Jun. 21, 2023, all of which are incorporated herein by reference in their entirety.

### TECHNICAL FIELD

The present disclosure relates to the field of children products, in particular to a child safety seat, and a storage structure and a child safety seat provided with the storage structure.

### BACKGROUND

A child safety seat may be fixed to a vehicle seat for a child to sit in, to protect the child in the child safety seat from impacts or sudden changes during movement (for example sudden deceleration). In order to quickly and reliably install the child safety seat onto the vehicle seat, the child safety seat may be provided with an ISOFIX connector or a LATCH connector, and a receptacle is provided on the vehicle seat, so that the ISOFIX connector or the LATCH connector may be easily fixed into the receptacle of the vehicle seat to form an ISOFIX system or a LATCH system.

The LATCH connector includes a LATCH plug and a connecting strap (such as a webbing). The LATCH plug is connected with a receptacle. The connecting strap has one end connected with the LATCH plug and the other end fixed to a mounting seat outside a seat shell of the child safety seat, and the mounting seat protrudes outward relative to the seat shell. When the child safety seat is in a backward working mode, it is easy for the mounting seat to collide with other passengers within the vehicle.

When the LATCH connector is not used, the plug is usually hung on a backrest of the child safety seat or other positions to simply fix the LATCH connector, but this fixing method may lead to exposure of the webbing, resulting in an untidy overall appearance of the child safety seat. Furthermore, hanging the connecting member on the seat cannot completely fix the LATCH plug, and any movement or bump can cause shaking the LATCH plug or the webbing connected thereto, so that the LATCH plug collides with the child safety seat to scratch the child safety seat or generate noise, even obstruct or interfere with other objects around it, resulting in poor user experience.

In addition, the child safety seat is generally provided with instruction manuals and some small components, and a user may put them in a glove box or a central armrest box of the vehicle, so that they can be found conveniently when needed, but they will occupy a limited space in the vehicle to some extent.

### SUMMARY

The present disclosure provides a child safety seat, including: a seat shell provided with a connecting through hole on an outer side surface of the seat shell; and a connecting assembly including a connecting strap and a plug; the connecting strap having a first end that is limited after entering an internal space surrounded by the outer side surface of the seat shell through the connecting through hole, and a second end that is connected with the plug for detachably connecting with a receptacle of a vehicle seat.

In an embodiment, the seat shell includes a seat part and a backrest part; the child safety seat further includes a shoulder strap, and the shoulder strap has a first end attached to the seat part and a second end extending backward from the backrest part; the connecting strap is connected with the shoulder strap, and a position where the connecting strap is connected with the shoulder strap is close to the first end of the shoulder strap.

In an embodiment, the seat part is provided with a first hole, and at least one of the first end of the shoulder strap and the first end of the connecting strap passes through the first hole and is connected with a first stopper, and the shoulder strap and the connecting strap are connected through the first stopper.

In an embodiment, when the shoulder strap and the connecting strap are tensioned, the shoulder strap and the connecting strap apply pulling forces in opposite directions to the first stopper.

In an embodiment, the seat part is also provided with a second hole and a third hole; the first hole is positioned between the second hole and the third hole; and the second hole is closer to a longitudinal center plane of the seat shell than the third hole; the first end of the connecting strap passes through the third hole and the first hole in turn and is connected with the first stopper, and the first stopper is positioned above the first hole; the first end of the shoulder strap passes through the first hole and the second hole in turn and is connected with a second stopper, and the second stopper is positioned above the second hole; and the shoulder strap is connected with the first stopper.

In an embodiment, the seat part is further provided with a fourth hole, and the fourth hole is closer to a longitudinal center plane of the seat shell than the first hole; the first end of the shoulder strap passes through the fourth hole and the first hole in turn, and is connected with the first stopper, and the first stopper is positioned above the first hole; the first end of the connecting strap is connected with the first stopper.

In an embodiment, the seat part is further provided with a fifth hole, and the fifth hole is closer to a longitudinal center plane of the seat shell than the first hole; the first stopper is positioned below the first hole and the fifth hole, the first end of the connecting strap passes through the first hole and is connected with the first stopper, and the shoulder strap passes through the fifth hole and is connected with the first stopper.

In an embodiment, the first stopper is positioned below the first hole, and both the first end of the shoulder strap and the first end of the connecting strap pass through the first hole, and are connected with the first stopper.

In an embodiment, the seat part is provided with a first hole, a second hole and a third hole; the third hole is positioned between the first hole and the second hole, and the second hole is closer to a longitudinal center plane of the seat shell than the first hole; the first end of the connecting strap passes through the third hole and the first hole in turn and is connected with a first stopper, and the first stopper is positioned above the first hole; the first end of the shoulder strap passes through the third hole and the second hole in turn and is connected with a second stopper, and the second stopper is positioned above the second hole.

In an embodiment, a positioning part is provided at the outer side surface of the seat shell, and the plug is suitable for being connected with the positioning part; and/or the child safety seat further includes a top fastening strap assembly, and the top fastening strap assembly includes two first fastening straps extending from left and right sides of the outer side surface of the seat shell, and a second fastening strap connected with the two first fastening straps, and an anchor is provided at an end of the second fastening strap.

In an embodiment, the positioning part includes a support seat and a rod, the support seat protrudes from the outer side surface of the seat shell, two ends of the rod are connected with the support seat, and the plug is suitable for hooking onto the rod; or, the positioning part includes a rib plate extending from the outer side surface of the seat shell, and the rib plate is provided with a perforation, and the plug is hooked onto the rib plate through the perforation.

In an embodiment, the connecting strap is directly connected with the shoulder strap.

An object of the present disclosure is to provide a child safety seat with a storage function.

An object of the present disclosure is to provide a child safety seat capable of accommodating a LATCH structure.

An object of the present disclosure is to provide a storage structure for the child safety seat.

An object of the present disclosure is further to provide a storage structure on a child safety seat for accommodating the LATCH structure.

Therefore, the present disclosure provides a storage structure for storing objects. The storage structure includes a shell provided on a child safety seat and forming a storage space for storing objects.

In an embodiment, the storage structure further includes a cover pivotally connected with the shell and configured to close an opening of the storage space.

In an embodiment, a mutually matched engagement structure is provided between the shell and the cover, and the engagement structure includes: a first engagement member provided at one of the shell and the cover; and a second engagement member provided at the other one of the shell and the cover, in which the first engagement member and the second engagement member are correspondingly provided and engaged with each other.

In an embodiment, the first engagement member is an engaging part on the shell, and the second engagement member is an engagement hook at an edge of the cover.

In an embodiment, the first engagement member is a positioning projection, and the second engagement member is a positioning hole capable of engaging with the positioning projection.

In an embodiment, the positioning projection is provided at a position where an upper surface of the shell is close to an edge of the opening.

In an embodiment, a transition portion is formed at an upper edge of the cover, the transition portion is fit to an upper surface of the shell, and the positioning hole is provided on the transition portion and corresponds to the positioning projection.

In an embodiment, the engagement structure is provided at a first side of the cover and the shell, and a pivot structure is provided at a second side of the cover opposite to the first side and the shell.

In an embodiment, the pivot structure includes a rotating shaft, and the rotating shaft is provided at one of the shell and the cover.

In an embodiment, the rotating shaft is a connecting pin on the shell, and the connecting pin is capable to be matched with a connecting hole at an end of the cover, so that the cover is pivotably connected to the shell.

In an embodiment, guiding parts are provided on both sides of the cover, for guiding the cover to be closed relative to the shell, and the connecting hole is formed on each of the guiding parts.

In an embodiment, the cover includes a plane portion positioned outside the storage space, for covering the opening of the storage space; and a bending portion having one end fixedly connected to the plane portion and the other end connected with an end wall of the shell through the rotating shaft, and the rotating shaft is fixed to one of the bending portion and the shell, when the cover is opened relative to the storage space, the bending portion is pivotably coupled to the end wall of the shell to prevent the cover from being separated from the shell.

In an embodiment, at least one of the shell and the cover is provided with a notch.

In an embodiment, the storage structure is provided at a rear of a base of the child safety seat and is positioned below a seating part of the child safety seat.

In an embodiment, an avoidance space is formed between a back side of the seat part and the base of the child safety seat.

In an embodiment, the seating part is supported above the base by support rods symmetrically provided on both sides of the child safety seat, and the avoidance space is positioned between the support rods on both sides thereof.

In an embodiment, the avoidance space is positioned in the middle of the child safety seat in a lateral direction.

In an embodiment, the storage structure is provided to protrude upward from the rear of the base and extend into the avoidance space.

In an embodiment, the storage structure is provided at a lateral middle position of the rear of the base.

In an embodiment, wherein the storage structure is provided at a top surface of the seating part of the child safety seat.

In an embodiment, the storage structure is provided at a position of the seating part close to an armrest which a LATCH structure passes through.

The present disclosure further provides a child safety seat including the storage structure according to any one of the preceding embodiments.

The present disclosure further provides a child safety seat. The child safety seat is provided with a LATCH structure for fixing the child safety seat on a vehicle, at least a portion of the LATCH structure is connected to the child safety seat. The LATCH structure is capable to be stored in the storage structure according to any one of the above embodiments.

In an embodiment, the LATCH structure includes a connecting strap having one end that is a fixed end and fixed on a base of the child safety seat, and the other end that is a ring-shaped end with a collar; and a fixing strap slidably inserted to the ring-shaped end; connecting members respectively provided at both ends of the fixing strap and detachably engaged with connecting points on the vehicle.

In an embodiment, the LATCH structure further includes an adjuster, and the adjuster is provided on the fixing strap to adjust a length of the fixing strap.

### BRIEF DESCRIPTION OF THE DRAWINGS

The accompanying drawings are included herein to provide further understanding of the present disclosure and are incorporated into this specification, forming a part of the specification. The drawings illustrate embodiments of the present disclosure and are used in conjunction with the following description to explain the concepts of the present disclosure.

FIG. 1 schematically shows a front perspective view of a child safety seat according to an embodiment of the present disclosure.

FIG. 2 schematically shows a lateral perspective view of a child safety seat according to an embodiment of the present disclosure, in which a flexible covering on a seat shell is omitted, and the seat shell is mounted backward on a vehicle seat.

FIG. 3 schematically shows another front perspective view of a child safety seat according to an embodiment of the present disclosure, in which the flexible covering on the seat shell is omitted.

FIG. 4 schematically shows an enlarged view at A in FIG. 3.

FIG. 5 schematically shows a sectional view at B-B in FIG. 3, in which a limiting mode of a connecting strap and a shoulder strap is shown.

FIG. 6 schematically shows a perspective view of a seat shell of a child safety seat according to an embodiment of the present disclosure.

FIG. 7 schematically shows an enlarged view at C in FIG. 6.

FIG. 8 schematically shows a sectional view at D-D in FIG. 6.

FIG. 9 schematically shows an enlarged view at E in FIG. 8.

FIG. 10 schematically shows a variant of a sectional view as shown in FIG. 5, in which another limiting mode of the connecting strap and the shoulder strap is shown.

FIG. 11 schematically shows another variant of a sectional view as shown in FIG. 5, in which another limiting mode of the connecting strap and the shoulder strap is shown.

FIG. 12 schematically shows further variant of a sectional view as shown in FIG. 5, in which further limiting mode of the connecting strap and the shoulder strap is shown.

FIG. 13 schematically shows another variant of a sectional view as shown in FIG. 5, in which another limiting mode of the connecting strap and the shoulder strap is shown.

FIG. 14 schematically shows further variant of a sectional view as shown in FIG. 5, in which further limiting mode of the connecting strap and the shoulder strap is shown.

FIG. 15 schematically shows further another variant of a sectional view as shown in FIG. 5, in which further another limiting mode of the connecting strap and the shoulder strap is shown.

FIG. 16 schematically shows a rear perspective view of a child safety seat according to an embodiment of the present disclosure.

FIG. 17 shows a perspective view of a child safety seat according to another embodiment of the present disclosure.

FIG. 18 shows a perspective view of the child safety seat shown in FIG. 17 viewed from another angle.

FIG. 19 shows a LATCH structure according to another embodiment of the present disclosure.

FIG. 20 shows another perspective view of the child safety seat shown in FIG. 18, in which a cover of a storage structure is opened.

FIG. 21 shows a lateral sectional view of the child safety seat shown in FIG. 18.

FIG. 22 shows a perspective view of a child safety seat according to another embodiment of the present disclosure.

FIG. 23 shows another perspective view of the child safety seat shown in FIG. 22, in which a cover of the storage structure is opened.

FIG. 24 shows a perspective view of the cover shown in FIG. 23.

FIG. 25 shows another perspective view of the child safety seat shown in FIG. 23, in which the cover is removed.

FIG. 26 shows a lateral sectional view of the child safety seat shown in FIG. 23.

FIG. 27 shows a perspective view of a seat part of a child safety seat according to another embodiment of the present disclosure.

FIG. 28 shows another perspective view of the seat part shown in FIG. 27, in which a cover of the storage structure is opened.

FIG. 29 shows a lateral view of the seat part shown in FIG. 27.

FIG. 30 shows a sectional view taken along a line A-A in FIG. 29.

### List of Reference Numbers

child safety seat 100
   seat shell 1
      internal space 10
      outer side surface 11
         connecting through hole 110
      seat part 13
         first hole 101
         second hole 102
         third hole 103
         fourth hole 104
         fifth hole 105
         opening 130
         side wing 131
         groove 132
         locking mechanism 137
      backrest part 14
         side wing 141
      positioning part 15
         support seat 151
         rod 152
      flexible covering 16
      foam plastic 17
      headrest 19
   shoulder strap hole 140
   vent hole 145
   connecting assembly 2
      connecting strap 21
         first end 211
         second end 212
      plug 22
   strap system 3
      shoulder strap 31
         first end 31a
      adjusting strap 32
      cross strap 33
      fastener 34
      fastener 35
      first stopper 41
      second stopper 42
      stopper 43
   top fastening strap assembly 5
      first fastening strap 51
      second fastening strap 52
      anchor 53
   base 9
   longitudinal center plane S
seating part 500A, 500B
   sitting portion 500Aa, 500Ba
   support rod 501A, 501B
   avoidance space 502A, 502B
base 600A, 600B
   upper cover 601B
   lower cover 602B
   storage structure 610A, 610B
      storage space 610Aa, 610Ba
      shell 611A, 611B
         first notch 6111A
         engagement part 6112A
         positioning projection 6111B
      cover 612A, 612B
         plane portion 612Aa
         bending portion 612Ab
         second notch 6121A
         engagement hook 6122A
         transition portion 612Ba
         positioning hole 6121B
         extension portion 6122B
         guide portion 6123B
         connecting post 6124B
         connecting hole 6125B
      rotating shaft 613A
      connecting pin 613B
   LATCH structure 300
      fixing strap 310
      connecting strap 320
         ring-shaped end 320a
         fixed end 320b
      connecting member 330
      adjuster 340
   seating part 400
      sitting portion 400a
      armrest 401
         avoidance hole 401a
   LATCH storage structure 410
      storage space 410a
      shell 411
         engagement part 4112
      cover 412
         engagement hook 4122
      pivot part 413

### DETAILED DESCRIPTION

Hereinafter, exemplary embodiments of the present disclosure will be described in detail with reference to accompanying drawings. Although various modifications and alternatives may be easily made to the present disclosure, the specific embodiments thereof may be illustrated by way of examples in the accompanying drawings; however, the present disclosure is not to be limited to the specific embodiments disclosed herein. Instead, all modifications, equivalents, and alternatives falling within the spirit and scope of the present disclosure will be covered.

The present disclosure will be described in detail with reference to the accompanying drawings.

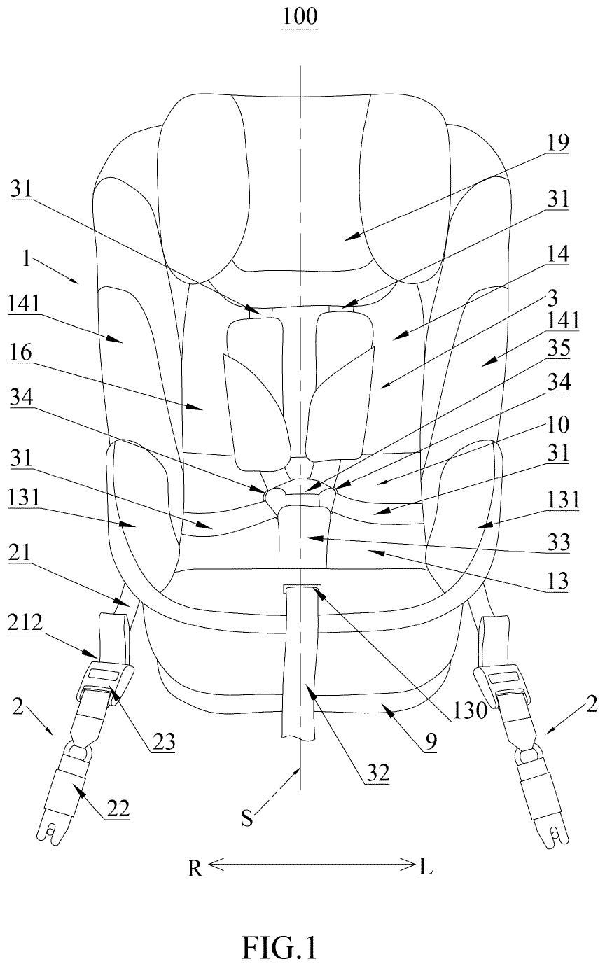

FIGS. 1 to 3 show perspective views of a child safety seat 100 according to an embodiment of the present disclosure. The child safety seat may include a base 9 and a seat shell 1 provided on the base 9. A connecting assembly 2 and a strap system 3 may be mounted on the seat shell 1.

The base 9 may be placed on a vehicle seat (not shown) and provide stable support for the seat shell 1. In some embodiments, the seat shell 1 may be angularly adjusted relative to the base 9. The seat shell 1 is shaped to a seat for accommodating a child, and may be mounted in a forward or backward mode on the vehicle seat (not shown), for example. When the seat shell 1 is mounted on the vehicle seat in a forward mode, the child sitting therein faces a front of the vehicle, and when the seat shell 1 is mounted on the vehicle seat in a backward mode, the child sitting therein faces a rear of the vehicle. In some embodiments, for example, the seat shell 1 may be mounted on the vehicle seat only in the forward or backward mode.

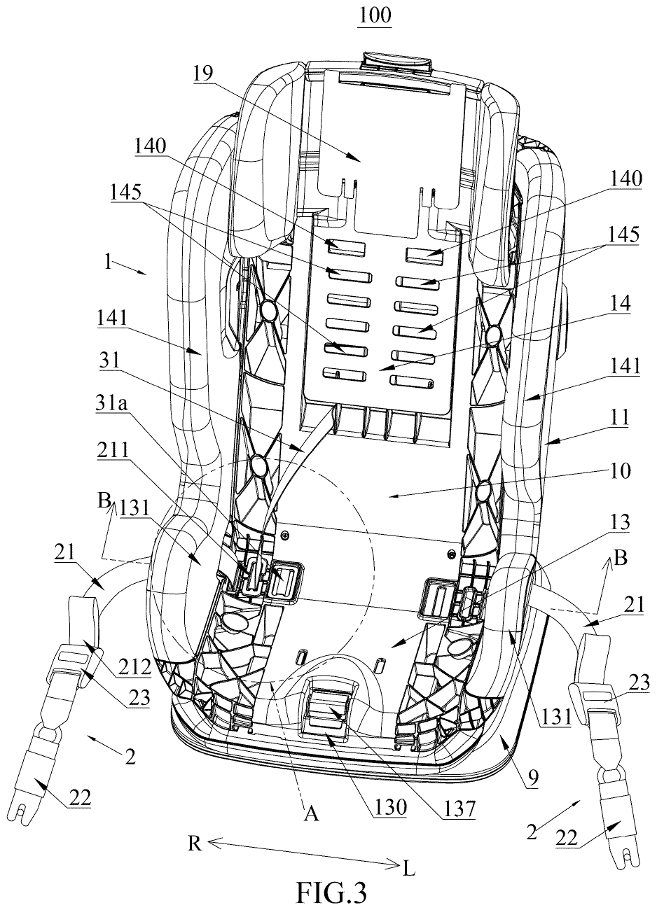

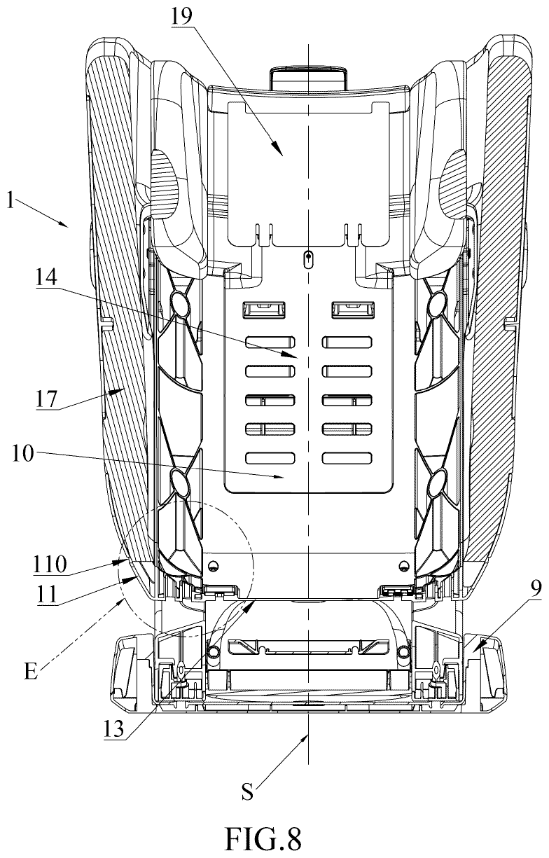

Referring to FIG. 3, the seat shell 1 may include a seat part 13 and a backrest part 14. The seat shell 1 may be a plastic molded part, and a foam plastic 17 may be attached to the seat shell 1 (see FIG. 8), so that the seat shell 1 has buffering performance. Referring to FIG. 1, an inner side of the seat shell 1 and the foam plastic 17 facing the child may be wrapped by a flexible covering 16, such as a seat cloth. Buffering fillers may also be filled between the flexible covering 16, the seat shell 1 and the foamed plastic 17, and the buffering fillers include, for example, a sponge layer.

Referring to FIGS. 1 and 3, the seat part 13 is configured to support a buttock of the child, and the backrest part 14 is configured to support a back of the child. In some embodiments, the seat part 13 and the backrest part 14 may, for example, include an integral injection molded part. Side wings 131 lifted upward may be provided on both sides of the seat part 13, and side wings 141 extending forward may be provided on both sides of the backrest part 14. The foam plastic 17, for example, is mainly attached to inner sides of the side wings 141. These side wings 141 may better position the child in the seat shell 1. The backrest part 14 may be provided with a headrest 19, and a height of the headrest 19 may be adjusted to be customized to a riding height of the child. Referring to FIG. 3, the headrest 19 may also be provided with a shoulder strap hole 140. In some embodiments, the headrest 19 may also be provided with a plurality of vent holes 145.

Referring to FIGS. 1 and 3, a strap system 3 is attached to the seat shell 1 for restraining the child in the seat shell 1. The strap system 3 may include two shoulder straps 31, an adjusting strap 32 and a crotch strap 33.

The two shoulder straps 31 may be symmetrically provided with respect to a longitudinal center plane S of the seat shell. A first end 31a of each shoulder strap 31 is attached to the seat part 13, and a second end (not shown) of each shoulder strap 31 extends downward behind the backrest part 14 after passing through the shoulder strap hole 140 of the headrest 19, and may be connected with one end of the adjusting strap 32 by any suitable connecting member (not shown). The other end of the adjusting strap 32 extends forward and protrudes from an opening 130 of the seat part 13. A fastener 34 may be provided in the middle of each shoulder strap 31. The crotch strap 33 has a first end attached to the seat part 13 and a second end provided with a fastener 35.

When the child sits in the seat shell 1, the fasteners 34 of the two shoulder straps 31 are fastened with the fasteners 35 of the crotch strap 33, and then the adjusting strap 32 is pulled to increase a length of the adjusting strap 32 protruding out of the opening 130 and reduce a length of each shoulder strap 31 in front of the backrest part 14 to tighten the child, such that the child can be reliably restrained in the seat shell 1. The seat part 13 is further provided with a locking mechanism 137 for locking the adjusting strap 32. When the locking mechanism 137 is in a locked state, it is allowed to pull the adjusting strap 32 out of the opening 130 to tighten the shoulder strap 31, but not retract the adjusting strap 32 into the opening 130 (the retraction of the adjusting strap 32 to the opening 130 can be achieved by pulling the shoulder strap 31), so as to avoid from loosening the shoulder strap 31 due to the retraction of the adjusting strap 32 into the opening 130. When the locking mechanism 137 is in an unlocked state, the adjusting strap 32 may be pulled out of the opening 130 or retracted into the opening 130.

It should be noted that unless otherwise specified and limited, the terms such as “left” and “right” in the embodiments of the present disclosure are based on the “left” and “right” orientations of the child sitting in the child safety seat 100, and the “left” and “right” directions are schematically shown by arrows L and R in the drawings. These terms are merely used to make the description of the embodiments of the present disclosure clearer, and are not intended to impose improper limitation on a protection scope of the present disclosure.

Referring to FIGS. 1 and 3 again, a connecting assembly 2 is provided on both sides of the seat shell 1, respectively. The connecting assembly 2 includes a connecting strap 21 and a plug 22. The connecting strap 21 is a webbing, for example. A first end 211 of the connecting strap 21 is connected with the seat shell 1, and a second end 212 of the connecting strap 21 is connected with the plug 22. For example, the plug 22 is a LATCH plug. The LATCH plug may be detachably connected with the receptacle on the vehicle seat, such that the child safety seat is fixed on the vehicle seat.

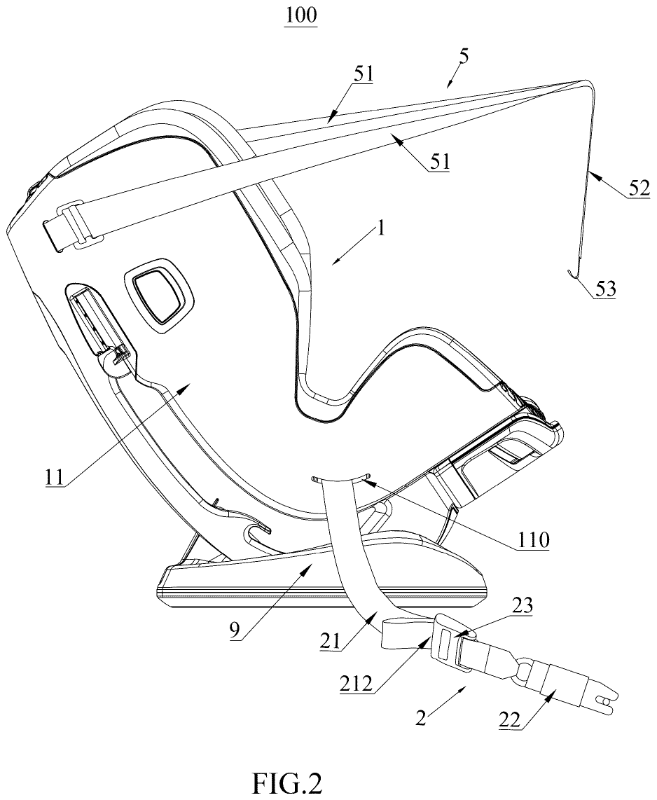

Referring to FIG. 2, in this embodiment, a connecting through hole 110 is provided at an outer side surface 11 of either side of the seat shell 1. The first end 211 of the connecting strap 21 is limited after entering an internal space 10 (see FIG. 3) surrounded by the outer side surface 11 of the seat shell 1 through the corresponding connecting through hole 110, thereby realizing the connection of the connecting strap 21 with the seat shell 1. The first end 211 of the connecting strap 21 may be limited by any suitable means as long as the first end 211 of the connecting strap 21 may not be pulled out through the connecting through hole 110. In some embodiments, the connecting through hole 110 may be an arc-shaped slit, and the first end 211 of the connecting strap 21 may be limited by any suitable structure after entering the internal space 10 from the slit. In addition, the connecting through hole 110 allows the connecting strap 21 to slide back and forth in the connecting through hole 110 to adapt to a specific installation direction of the seat shell 1 on the vehicle seat. In some embodiments, the plug 22 is detachably connected with the second end 212 of the connecting strap 21, for example, through an adjuster 23 which may adjust a length of the connecting strap 21.

Continuing to refer to FIG. 2, in some embodiments, the seat shell 1 may also be provided with a top fastening strap assembly 5 attached thereto. The top fastening strap assembly 5 is configured to connect an upper portion of the seat shell 1 with an anchoring point inside the vehicle, so as to further ensure connection stability of the child safety seat 100 with the vehicle seat. The top fastening strap assembly 5 includes, for example, two first fastening straps 51 and one second fastening strap 52. First ends of the two first fastening straps 51 are respectively connected to left and right sides of the outer side surface 11 of the seat shell 1, and the second ends of the two first fastening straps 51 are connected with the first ends of the second fastening straps 52 after passing over the vehicle seat (not shown), and a second end of the second fastening strap 52 is provided with an anchor 53 for connecting with the above-mentioned anchoring point. The anchor 53 may be, for example, but not limited to, a hook. Of course, in some embodiments, the second fastening strap 52 may also be formed by extending one of the first fastening straps 51.

The embodiment of the present disclosure provides the connecting assembly 2, in which the first end 211 of the connecting strap 21 may be limited in a direct or indirect connection with the seat shell 1 after entering the internal space 10 through the connecting through hole 110, so that it is not necessary to provide a mounting seat for fixing the connecting strap 21 on the outer side surface 11 of the seat shell 1, so as to avoid injury to other passengers due to the arrangement of the mounting seat, and also simplify the structure of the seat shell 1 to make the seat shell 1 have a clean appearance.

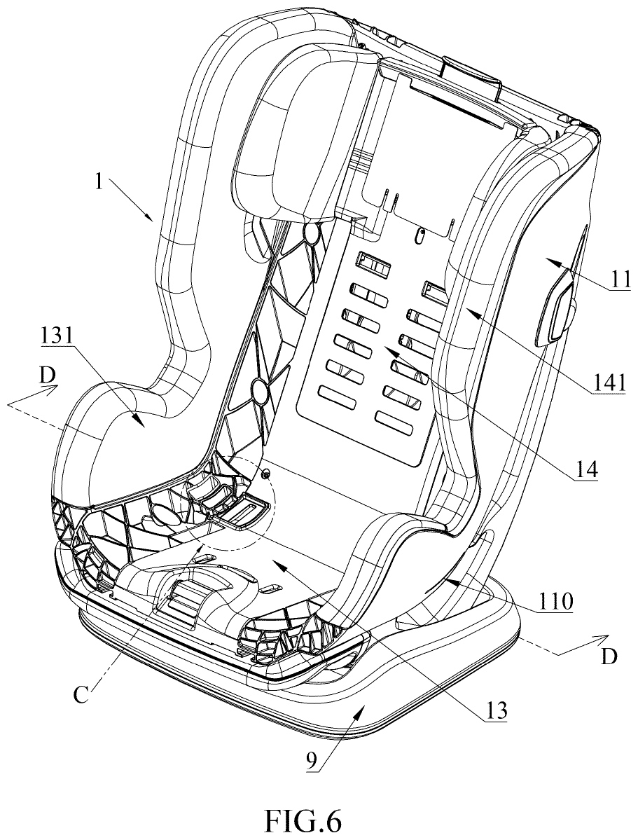

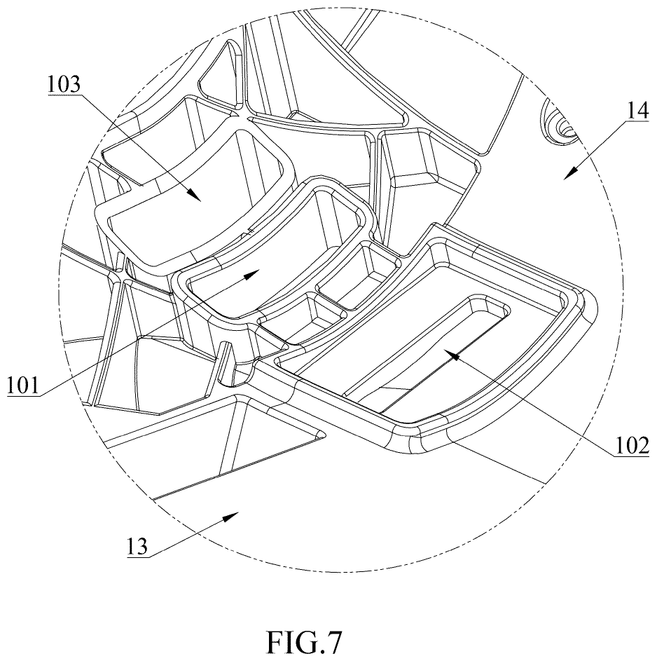

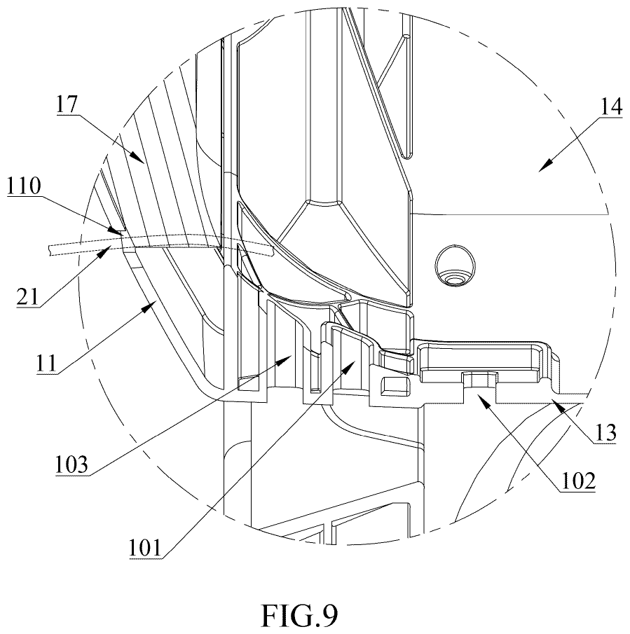

FIGS. 3 to 5 show a limiting mode of the first end 211 of the connecting strap 21. Referring to FIGS. 6 to 9, the seat part 13 is provided with a first hole 101, a second hole 102 and a third hole 103. The first hole 101, the second hole 102 and the third hole 103 may be provided side by side and close to the backrest part 14. In some embodiments, the first hole 101 is positioned between the second hole 102 and the third hole 103, and the second hole 102 is closer to the longitudinal center plane S of the seat shell 1 than the third hole 103. The connecting through hole 110 is farther away from the longitudinal center plane S than the third hole 103. The first end 211 of the connecting strap 21 passes through the connecting through hole 110 (see FIGS. 8 and 9), and then through the third hole 103 from top to bottom, and further through the first hole 101 from bottom to top, to connect with a first stopper 41 above the first hole 101. The first stopper 41 is sized larger than the first hole 101, and the first stopper 41 is, for example, a “ [symbol] ”-shaped button (i.e., a tri-glide button), a “ [symbol] ”-shaped button (i.e., a stair button) or other suitable components. The first stopper 41 abuts against an edge of the first hole 101, and limits a position of the first end 211 of the connecting strap 21, so as to realize the connection of the connecting strap 21 with the seat shell 1.

The first end 31a of the shoulder strap 31 passes through the first hole 101 from top to bottom, and through the second hole 102 from bottom to top, and then is connected with a second stopper 42 above the second hole 102. A size of the second stopper 42 is larger than a size of the second hole 102, and the second stopper 42 is, for example, a “ [symbol] ”-shaped button, a “ [symbol] ”-shaped button or other suitable components. The second stopper 42 abuts against an edge of the second hole 102, and limits a position of the first end 31a of the shoulder strap 31, so as to realize the connection of the first end 31a of the shoulder strap 31 with the seat shell 1.

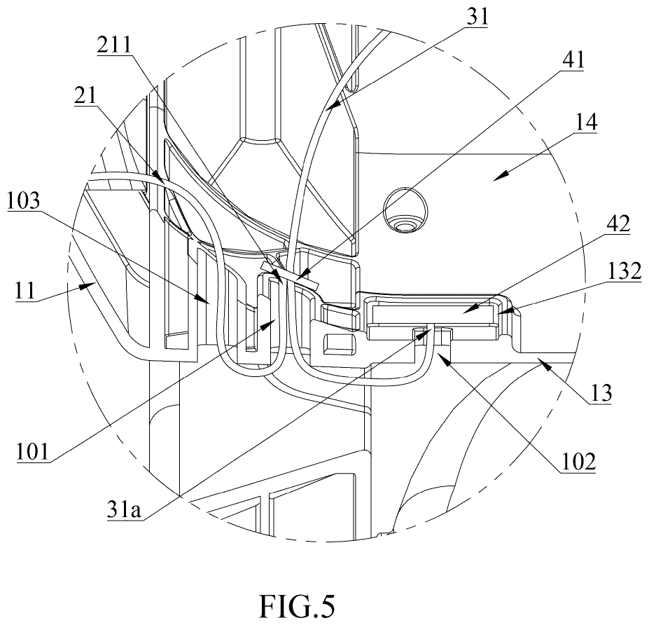

Referring to FIG. 5, the shoulder strap 31 is connected with the first stopper 41 when passing through the first stopper 41, so that the shoulder strap 31 and the connecting strap 21 are connected through the first stopper 41. When the child safety seat 100 is in a use state, both the connecting strap 21 and the shoulder strap 31 are tensioned, and the first stopper 41 may be subjected to a first pulling force downward from the connecting strap 21, while the first stopper 41 may be subjected to a second pulling force upward from the shoulder strap 31. The first pulling force and the second pulling force in opposite directions may be partially offset to reduce pressure exerted by the first stopper 41 on an edge of the first hole 101, so as to improve stress concentration at the connection between the seat part 13 and the connecting strap 21 and the shoulder strap 31, and ensure structural strength at the connection.

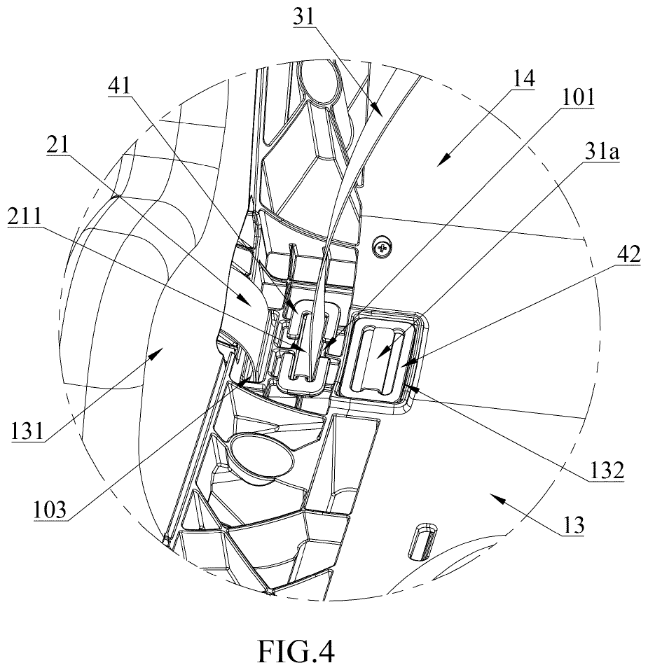

Referring to FIGS. 4 and 5, the seat part 13 may be further provided with a groove 132 for positioning the second stopper 42. In some embodiments, the seat part 13 may also be provided with a groove for positioning the first stopper 41.

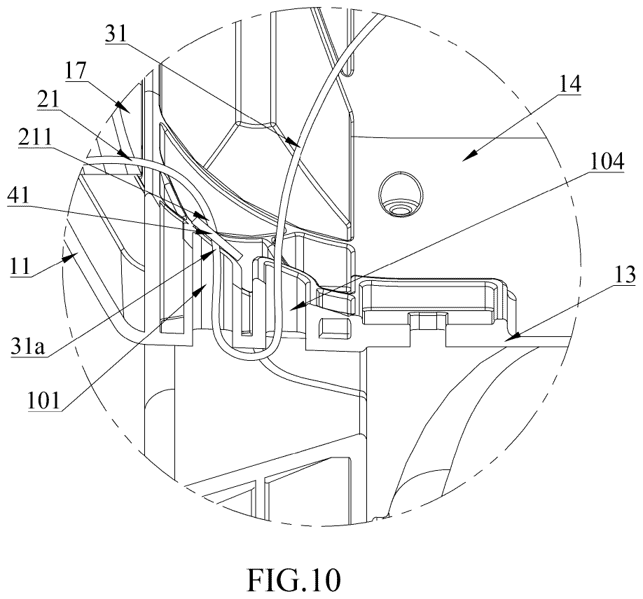

FIG. 10 shows another limiting mode of the first end 211 of the connecting strap 21. Specifically, a seat part 13 is provided with a first hole 101 and a fourth hole 104, which may be provided side by side and close to a backrest part 14. In some embodiments, the fourth hole 104 is closer to a longitudinal center plane S of the seat shell 1 than the first hole 101. The connecting through hole 110 is farther away from the longitudinal center plane S than the first hole 101. The first end 31a of a shoulder strap 31 passes through the fourth hole 104 from top to bottom, and through the first hole 101 from bottom to top, and then is connected with the first stopper 41 above the first hole 101. A size of the first stopper 41 is larger than a size of the first hole 101, and the first stopper 41 is, for example, a “ [symbol] ”-shaped button, a “ [symbol] ”-shaped button or other suitable components. The first stopper 41 abuts against an edge of the first hole 101, and limits a position of the first end 31a of the shoulder strap 31, so as to realize the connection of the shoulder strap 31 with the seat shell 1. The first end 211 of the connecting strap 21 extends downward after passing through the connecting through hole 110 and is connected with the first stopper 41, so that the first end 211 of the connecting strap 21 is limited. When the child safety seat is in a use state, the shoulder strap 31 and the connecting strap 21 that have been tensioned exert pulling forces in opposite directions to the first stopper 41, so as to improve the stress concentration at the connection of the seat part 13 with the connecting strap 21 and the shoulder strap 31.

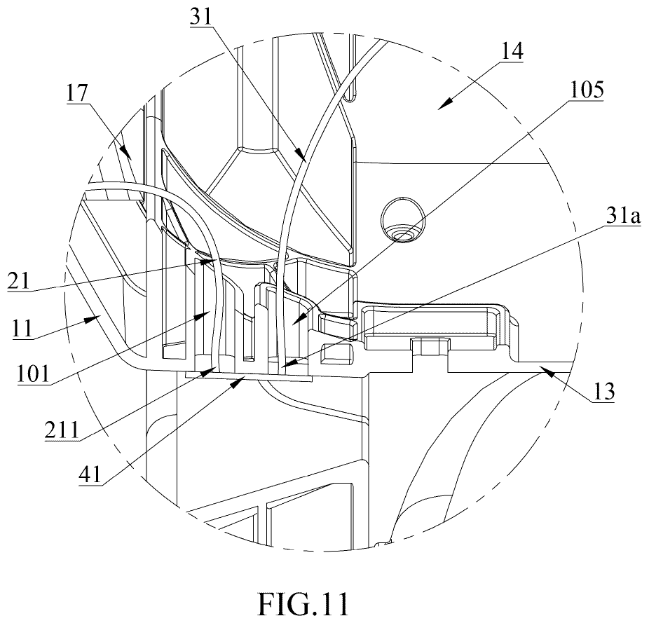

FIG. 11 shows another limiting mode of the first end 211 of the connecting strap 21. The seat part 13 is provided with a first hole 101 and a fifth hole 105, which may be provided side by side and close to the backrest part 14. In some embodiments, the fifth hole 105 is closer to a longitudinal center plane S of the seat shell 1 than the first hole 101. The connecting through hole 110 is farther away from the longitudinal center plane S than the first hole 101. A first stopper 41 is provided below the first hole 101 and the fifth hole 105. The first end 211 of the connecting strap 21 passes through the connecting through hole 110, and through the first hole 101 from top to bottom, and then is connected with the first stopper 41. The first end 31a of the shoulder strap 31 passes through the fifth hole 105 from top to bottom and then is also connected with the first stopper 41. The first stopper 41 is, for example, a “ [symbol] ”-shaped button, a “ [symbol] ”-shaped button or other suitable components. The first stopper 41 abuts against edges of the first hole 101 and the fifth hole 105, and limits positions of the first end 211 of the connecting strap 21 and the first end 31a of the shoulder strap 31, so as to realize the connection of the connecting strap 21 and the shoulder strap 31 with the seat shell 1.

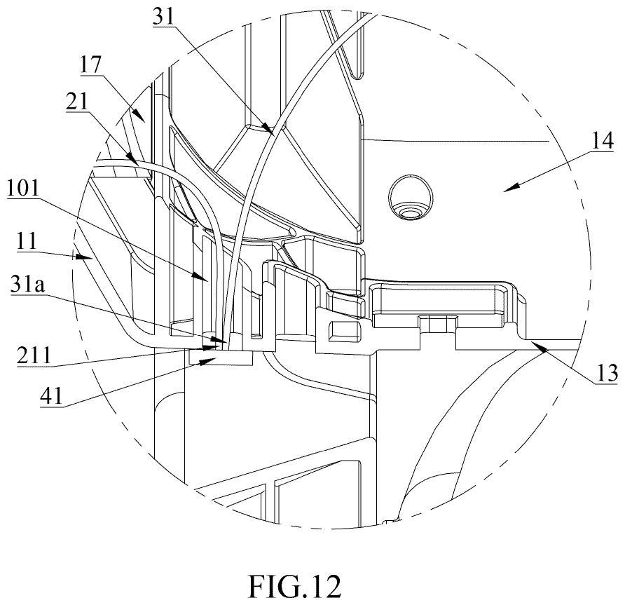

FIG. 12 shows further limiting mode of the first end 211 of the connecting strap 21. The seat part 13 is provided with a first hole 101. The first hole 101 is close to the backrest part 14 and away from a longitudinal center plane S. A first stopper 41 is provided below the first hole 101. The first end 211 of the connecting strap 21 passes through the connecting through hole 110, and through the first hole 101 from top to bottom, and then is connected with the first stopper 41. The first end 31a of a shoulder strap 31 passes through the first hole 101 from top to bottom and is also connected with the first stopper 41. The first stopper 41 is, for example, a “ [symbol] ”-shaped button, a “ [symbol] ”-shaped button or other suitable components. The first stopper 41 abuts against an edge of the first hole 101, and limits positions of the first end 211 of the connecting strap 21 and the first end 31a of the shoulder strap 31, so as to realize the connection of the connecting strap 21 and the shoulder strap 31 with the seat shell 1.

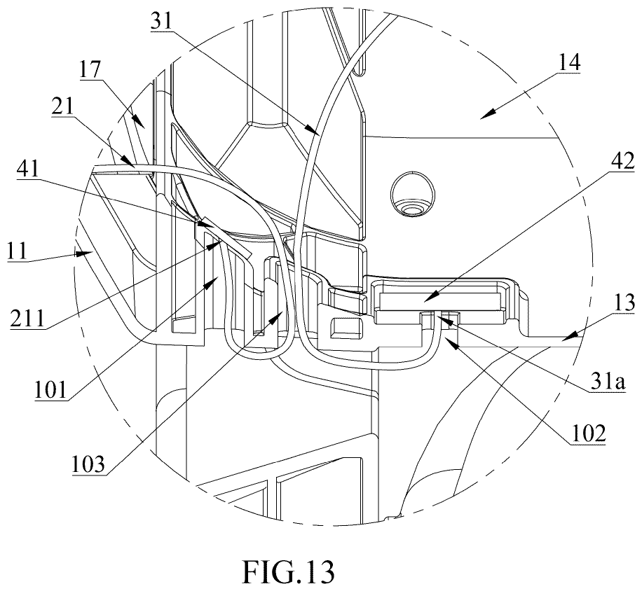

FIG. 13 shows further another limiting mode of the first end 211 of a connecting strap 21. The seat part 13 is provided with a first hole 101, a second hole 102 and a third hole 103, which may be provided side by side and close to the backrest part 14. In some embodiments, the third hole 103 is positioned between the first hole 101 and the second hole 102, and the second hole 102 is closer to a longitudinal center plane S of a seat shell 1 than the first hole 101. It may be understood from the above context that the connecting through hole 110 is farther away from the longitudinal center plane S than the first hole 101. The first end 211 of the connecting strap 21 passes through the connecting through hole 110, and through the third hole 103 from top to bottom, and then through the first hole 101 from bottom to top, and is connected with a first stopper 41 above the first hole 101. The first stopper 41 is sized larger than the first hole 101, and the first stopper 41 is, for example, a “ [symbol] ”-shaped button, a “ [symbol] ”-shaped button or other suitable components. The first stopper 41 abuts against an edge of the first hole 101, and limits a position of the first end 211 of the connecting strap 21, so as to realize the connection of the connecting strap 21 with the seat shell 1.

The first end 31a of the shoulder strap 31 passes through the third hole 103 from top to bottom, and through the second hole 102 from bottom to top, and then is connected with the second stopper 42 above the second hole 102. A sized of the second stopper 42 is larger than a sized of the second hole 102, and the second stopper 42 is, for example, a “ [symbol] ”-shaped button, a “ [symbol] ”-shaped button or other suitable components. The second stopper 42 abuts against an edge of the second hole 102, and limits a position of the first end 31a of the shoulder strap 31, so as to realize the connection of the first end 31a of the shoulder strap 31 with the seat shell 1.

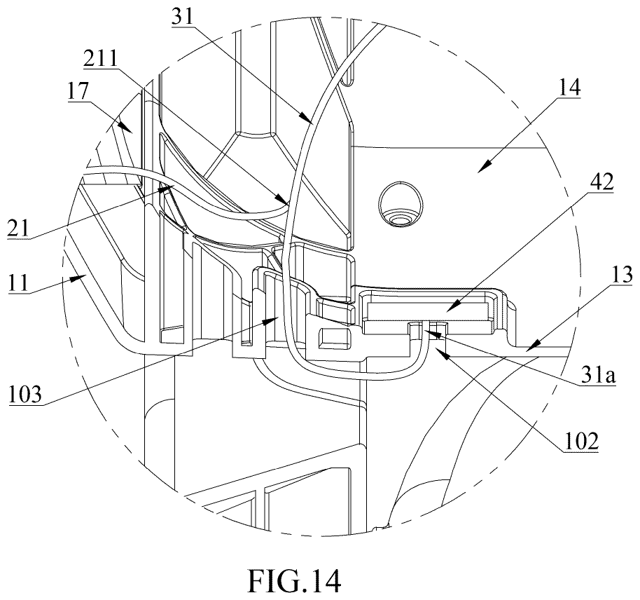

FIG. 14 shows further limiting mode of the first end 211 of the connecting strap 21. The seat part 13 is provided with a second hole 102 and a third hole 103, which may be provided side by side and close to the backrest part 14. In some embodiments, the second hole 102 is closer to a longitudinal center plane S of a seat shell 1 than the third hole 103. It may be understood from the above context that the connecting through hole 110 is farther away from a longitudinal center plane S than the third hole 103. The first end 31a of the shoulder strap 31 passes through the third hole 103 from top to bottom, and through the second hole 102 from bottom to top, and then is connected with the second stopper 42 above the second hole 102. A size of the second stopper 42 is larger than a size of the second hole 102, and the second stopper 42 is, for example, a “ [symbol] ”-shaped button, a “ [symbol] ”-shaped button or other suitable components. The second stopper 42 abuts against an edge of the second hole 102, and limits a position of the first end 31a of the shoulder strap 31, so as to realize the connection of the first end 31a of the shoulder strap 31 with the seat shell 1. The first end 211 of the connecting strap 21 passes through the connecting through hole 110 and then is directly connected with the shoulder strap 31 above the seat part 13, so that the first end 211 of the connecting strap 21 is limited. As can be seen from FIG. 14, a position where the connecting strap 21 is connected with the shoulder strap 31 is close to the first end 31a of the shoulder strap 31. In some embodiments, the first end 211 of the connecting strap 21 is directly connected to the shoulder strap 31, for example, by sewing.

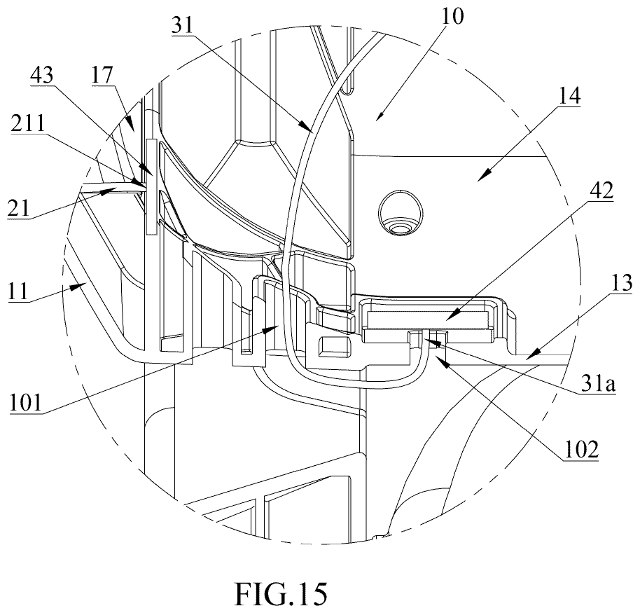

FIG. 15 shows further limiting mode of the first end 211 of the connecting strap 21. The first end 211 of the connecting strap 21, which enters a space 10 from the connecting through hole 110, may be connected with any stoppers 43 with appropriate shape and size, such as a “ [symbol] ”-shaped button and a “ [symbol] ”-shaped button. The stopper 43 can limit a position of the first end 211 of the connecting strap 21 to prevent the first end 22 of the connecting strap 21 from being pulled out of the connecting through hole 110. In some embodiments, the stopper 43 may be replaced by a bow knot.

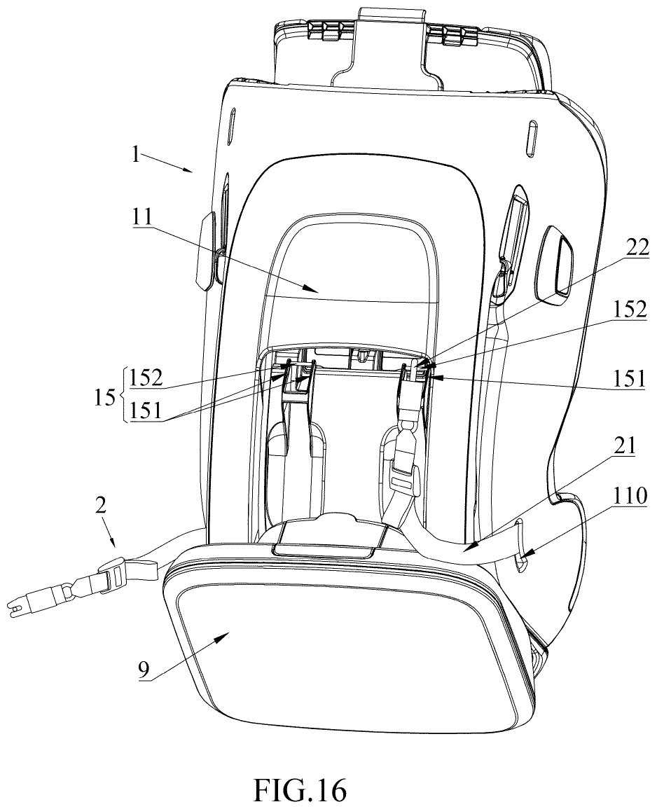

Referring to FIG. 16, in some embodiments, an outer side surface 11 of the seat shell 1 may also be provided with a positioning part 15. When the connecting assembly 2 is in a non-use state, a plug 22 is suitable to connect with the positioning part 15 to be positioned. This can prevent the plug 22 from being crushed due to moving below the seat shell 1 or a base 9.

In some embodiments, the positioning part 15 includes, for example, a support seat 151 and a rod 152. The support seat 151 is provided on the outer side surface 11 of the seat shell 1, and both ends of the rod 152 are connected with the support seat 151, and the plug 22 is suitable to be hooked on the rod 152. In some embodiments, the positioning portion 15 includes, for example, a rib plate provided on the outer side surface 11 of the seat shell 1. The rib plate has a perforation through which the plug 22 may be hooked onto the rib plate.

In some embodiments, two positioning parts 15 may be arranged on the outer side surface 11 of the seat shell 1. The two positioning parts 15 are symmetrically arranged with respect to the longitudinal center plane S of the seat shell 1, and the two positioning parts 15 correspond to the plugs 22 of the connecting assemblies 2 on both sides of the seat shell 1 one by one. In some alternative embodiments, one positioning part 15 may be centrally arranged on the outer side of the seat shell 1, and the plugs 22 of the connecting assemblies 2 on both sides of the seat shell 1 may be connected with the one positioning part 15.

Another embodiment of the present disclosure further provides a child safety seat.

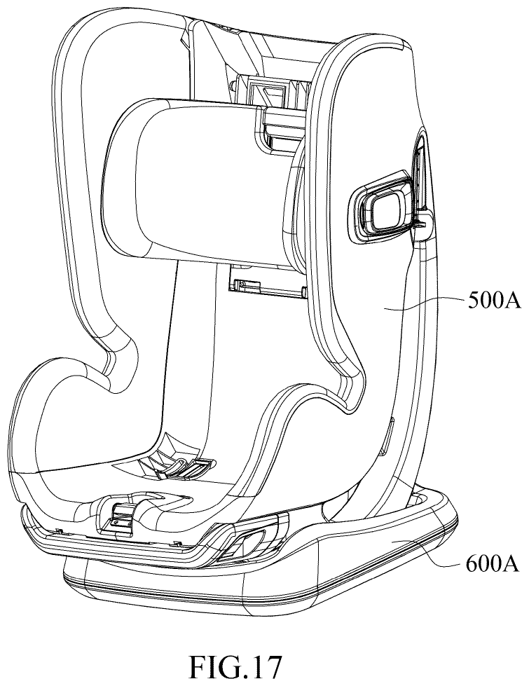

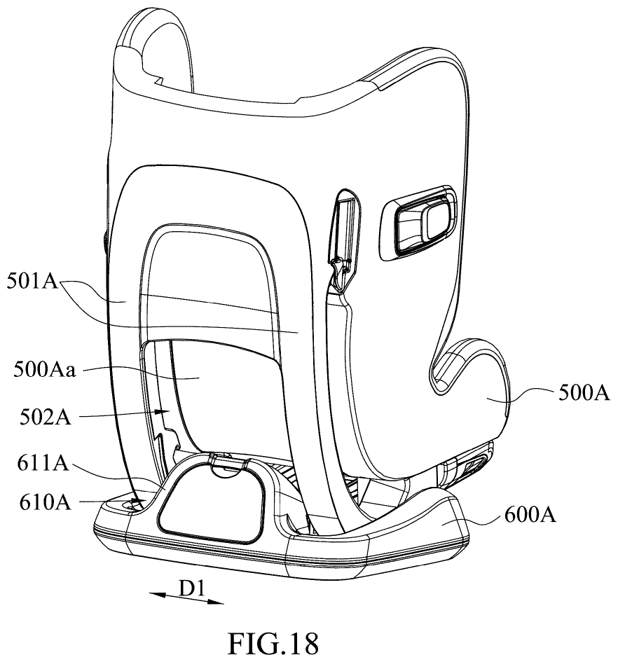

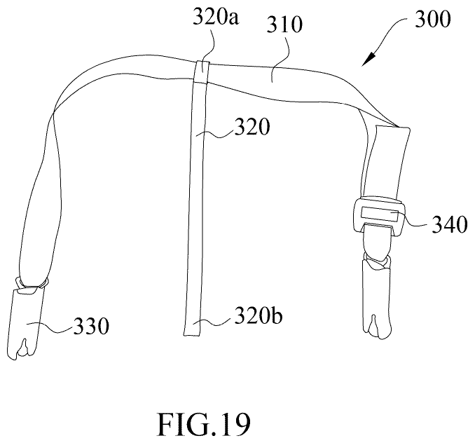

Referring to FIGS. 17 to 19, FIGS. 17 and 18 respectively show perspective views of a child safety seat according to an embodiment of the present disclosure viewed from different angles, in which FIG. 17 shows a front side of the child safety seat, FIG. 18 shows a rear side of the child safety seat, and FIG. 19 shows a LATCH structure 300 for the child safety seat shown in FIGS. 17 and 18.

As shown in FIGS. 17 and 18, the child safety seat of the present disclosure may include a seating part 500A and a base 600A below the seating part 500A. In this embodiment, it is considered that the seating part 500A may include the seat part and the backrest part as described in the previous embodiments, or may only include the seat part, and the present disclosure is not limited thereto. In addition, the child safety seat may further include a storage structure. The storage structure may be provided on the base or the seating part of the child safety seat and may be configured to store objects, such as connecting structures (such as a LATCH structure) used in cooperation with the child safety seat and/or related small components.

For example, in an embodiment, a LATCH structure 300 (shown in FIG. 19) may be provided on the child safety seat for fixing the child safety seat on a vehicle, and at least a portion of which is connected to the child safety seat. Accordingly, as shown in FIG. 18, the child safety seat may be provided with a storage structure for storing the LATCH structure 300 (also referred to as “LATCH storage structure 610A” in this embodiment), so that the LATCH structure 300, when not in use, may be stored in the LATCH storage structure 610A. This can keep an appearance of the child safety seat neat, and prevent the LATCH structure 300 from accidental collision with the seat or interference with other surrounding objects.

It should be noted that in order to more clearly illustrate the structure of the child safety seat of the present disclosure, the LATCH structure 300 is shown separately only in FIG. 19, and the state of mounting the LATCH structure 300 to the child safety seat is not shown in each of the figures. The specific arrangement and position of the LATCH structure 300 on the child safety seat will be described below with reference to FIGS. 18 and 19.

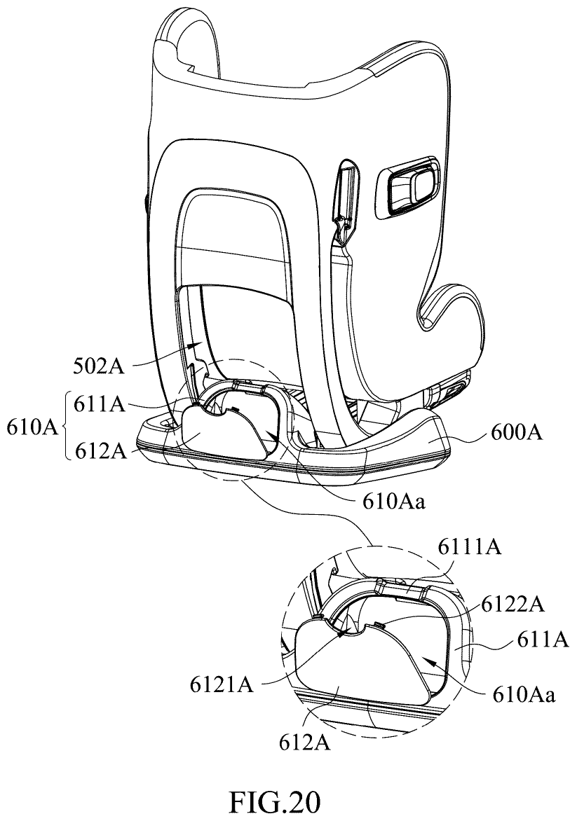

As shown in FIGS. 18 and 20, the LATCH storage structure 610A includes a shell 611A. The shell 611A is provided on the child safety seat and forms a storage space 610Aa for storing the LATCH structure 300. The storage space 610Aa may be sized to just accommodate the LATCH structure 300, so that the LATCH structure 300 may not slide when it is accommodated therein, and thus noise cannot be generated.

The LATCH storage structure 610A of the present disclosure may be provided at a rear of the base 600A of the child safety seat and positioned below the seating part 500A. The shell 611A of the LATCH storage structure 610A may be integrally formed with the base 600A. Specifically, an avoidance space 502A through which the LATCH structure 300 passes is formed between a back side of the seating part 500A and the base 600A. For example, as shown in FIG. 18, the seating part 500A may be supported above the base 600A by a support structure, and there is an interval distance between the back side of the seating part 500A and the base 600A to form the avoidance space 502A. In an example, the support structure includes support rods 501A symmetrically provided on both sides of the child safety seat, and the avoidance space 502A is positioned between the support rods 501A on both sides. More Optionally the avoidance space 502A is positioned in the middle of the child safety seat in a lateral direction D1. Optionally, the support structure may be inverted U-shaped, that is, the support rods 501A on both sides may be connected into a whole through a cross rod above the support rods 501A. Optionally or alternatively, the support structure may be integrally formed with the seating part 500A.

In an example, the LATCH storage structure 610A may be provided to protrude upward from the rear of the base 600A and protrude into the avoidance space 502A. That is, the LATCH storage structure 610A may be accommodated in the avoidance space 502A. More specifically, the LATCH storage structure 610A may be provided in a lateral middle position of the rear of the base 600A, for example, just behind and below a sitting portion 500Aa of the seating part 500A in which the child may sit.

By providing the avoidance space 502A at the rear side and/or a lower side of the child safety seat, it is not only convenient to fix the child safety seat to the vehicle seat by using the LATCH structure 300, but also provide a large space to accommodate the LATCH storage structure 610A protruding upward from the base 600A. This can avoid any influence of the LATCH structure 300 and the LATCH storage structure 610A on the angle adjustment of the seating part 500A relative to the base 600A.

In addition, as shown in FIG. 19, the LATCH structure 300 provided on the child safety seat may include a fixing strap 310, a connecting strap 320 and connecting members 330. One end of the connecting strap 320 is a fixed end 320b, which is fixed on the base 600A of the child safety seat, and the other end thereof is a ring-shaped end 320a with a collar. The fixing strap 310 is slidably inserted into the ring-shaped end 320a. The connecting members 330 are respectively provided on both ends of the fixing strap 310, and may be detachably engaged with the connecting points on the vehicle. Optionally, the LATCH structure 300 further includes an adjuster 340. The adjuster 340 is provided on the fixing strap 310 to adjust a length of the fixing strap 310.

Specifically, referring to FIGS. 18 and 19, the fixed end 320b of the connecting strap 320 may be provided on an upper surface of the base 600A and positioned in the avoidance space 502A between the seating part 500A and the base 600A. When the LATCH structure 300 is used to connect with the vehicle, the fixing strap 310 slidably connected relative to the ring-shaped end 320a of the connecting strap 320 may protrude from two sides of the avoidance space 502A, and engage with and lock to the connecting points of the vehicle through the connecting members 330 on the two ends of the fixing strap 310, thereby binding the base 600A of the child safety seat to the vehicle so as to fix the child safety seat. When the LATCH structure 300 is not used, the fixing strap 310 and the connecting member 330 may protrude backward from the avoidance space 502A and be accommodated in the LATCH storage structure 610A.

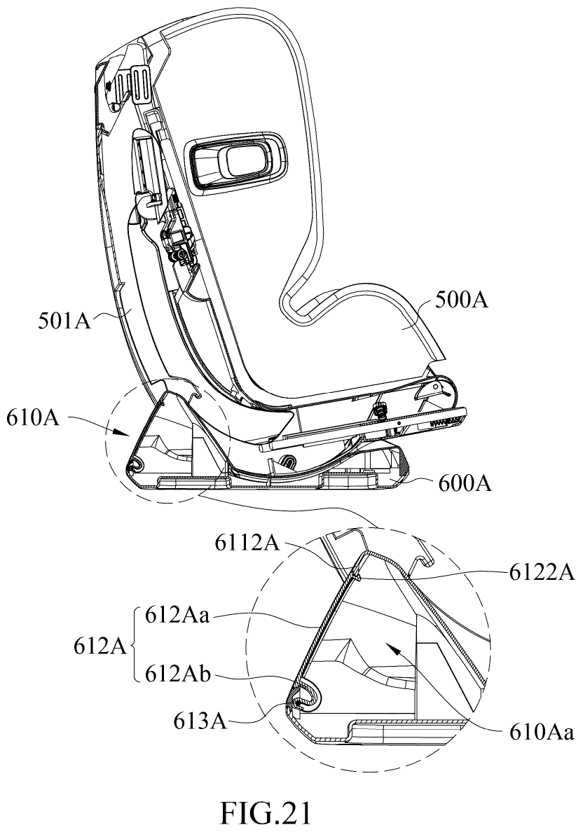

Further referring to FIGS. 20 and 21, FIG. 20 shows another perspective view of the child safety seat shown in FIG. 18, in which the LATCH storage structure 610A is in a cover-opened state; and FIG. 21 shows a lateral sectional view of the child safety seat shown in FIG. 18.

As shown in FIG. 20, the LATCH storage structure 610A further includes a cover 612A. The cover 612A is pivotally connected with the shell 611A to enclose an opening of the storage space 610Aa. Referring to FIGS. 20 and 21, a mutually matched engagement structure is provided between the shell 611A and the cover 612A, which includes a first engagement member and a second engagement member. In an embodiment, the engagement structure may include an engagement hook 6122A (used as the second engagement member) provided at an edge of the cover 612A to engage with an engagement part 6112A (used as the first engagement member) correspondingly provided on the shell 611A. In an example, an engagement structure is provided at the shell 611A and a first side of the cover 612A, and a pivot structure is provided at the shell 611A and a second side of the cover 612A opposite to the first side. For example, in this embodiment, the engagement structure is provided at a position where an upper side of the cover 612A and a position of the shell 611A corresponding to the upper side of the cover 612A, and the pivot structure is provided at a position where a lower side of the cover 612A and a position of the shell 611A corresponding to the lower side of the cover 612A. Specifically, as shown in FIG. 21, the lower side of the cover 612A is pivotally connected with the shell 611A, so that the cover 612A of the LATCH storage structure 610A may be opened downward, and the LATCH structure 300 (not shown) can enter the storage space 610Aa from above the LATCH storage structure 610a without interfering with the cover 612A. The upper side of the cover 612A is provided with an engagement hook 6122A engaged with the shell 611A. When the cover 612A is closed, the engagement hook 6122A engages with an upper wall of the shell 611A, specifically engages with an engagement part 6112A on the shell 611A. Of course, the present disclosure is not limited thereto. For example, the positions of the engagement member 6112A and the engagement hook 6122A may be interchanged, and they have different numbers.

In addition, an opening of the storage space 610Aa is provided obliquely, for example, the opening is inclined upward. That is, when the cover 612A pivotally connected with a lower portion of the shell 611A is closed, it forms an acute angle with the base 600A, as shown in FIG. 21, so as to prevent the cover 612A from being accidentally opened.

In an example, as shown in FIG. 21, the cover 612A includes a plane portion 612Aa and a bending portion 612Ab. The plane portion 612Aa is positioned outside the storage space 610Aa, for covering the opening of the storage space 610Aa. One end of the bending portion 612Ab is fixedly connected to a lower end of the plane portion 612Aa, and the other end thereof is connected with an end wall of the shell 611A through a pivot structure. The pivot structure includes a rotating shaft, and the rotating shaft is fixed to one of the bending portion 612Ab and the shell 611A. For example, as shown in FIG. 21, the rotating shaft is a rotating shaft 613A fixed on the shell 611A.

When the cover 612A is opened relative to the storage space 610Aa, the bending portion 612Ab may be pivotally coupled to the end wall of the shell 611A to prevent the cover 612A from being separated from the shell 611A. Specifically, in the process of opening the cover 612A, an inner surface of the bending portion 612A may abut against a surface of the end wall of the shell 611A, and may be sleeved the outer side of the end wall of the shell 611A when the cover 612A is completely opened, so as to prevent the cover 612A from continuing to rotate downward and limiting to an opening degree of the cover 612A. That is, as shown in FIG. 20, the end wall of the shell 611A may be used as a first limiting part, and the bending portion 612A may be used as a second limiting part. By the cooperation of the first limiting part and the second limiting part, an angle of opening the cover 612a relative to the shell 611A may be limited.

In addition, at least one of the shell 611A and the cover 612A is provided with a notch to avoid obstructing opening and closing of the cover 612A when the LATCH structure 610A (not shown) is stored in the storage space 610Aa. As shown in FIG. 20, in an example, the shell 611A may be provided with a first notch 6111A. For example, the first notch 6111A may be formed to be recessed from the upper wall of the shell 611A, and may have an arc shape, a square shape, or the like. In addition, the user may also open the cover 612A through the first notch 6111A, so that there is no need to additionally provide other devices for opening the cover. The cover 612A may be correspondingly provided with a second notch 6121A. The first notch 6111A and the second notch 6121A form an avoidance opening which the LATCH structure 300 (not shown) may pass through and be accommodated in the LATCH storage structure 610A.

It should be noted that FIG. 20 of the present disclosure shows an embodiment in which both the first notch 6111A and the second notch 6121A are provided. However, it should be understood that only the first notch 6111A or the second notch 6121A may be provided, and the present disclosure is not limited to the shapes and installation positions of the above embodiments.

By providing the LATCH storage structure 610A on the child safety seat, when the LATCH structure 300 is not used, the connecting member 330 and most of the straps (for example, the fixing strap 310 and a part of the connecting strap 320) may be stored in the storage space 610Aa of the LATCH storage structure 610A, to allow the appearance of the child safety seat neat. Furthermore, the storage space 610Aa is sized to just accommodate the connecting member 330 and the straps of the LATCH structure 300, so as to prevent generating noise due to the connecting member 330 sliding in the storage space 610Aa. In addition, the LATCH storage structure 610A of the present disclosure may be provided in the avoidance space 502A between the seating part 500A and the base 600A, providing a large storage space 610Aa without affecting the angle adjustment of the seating part 500A relative to the base 600A.

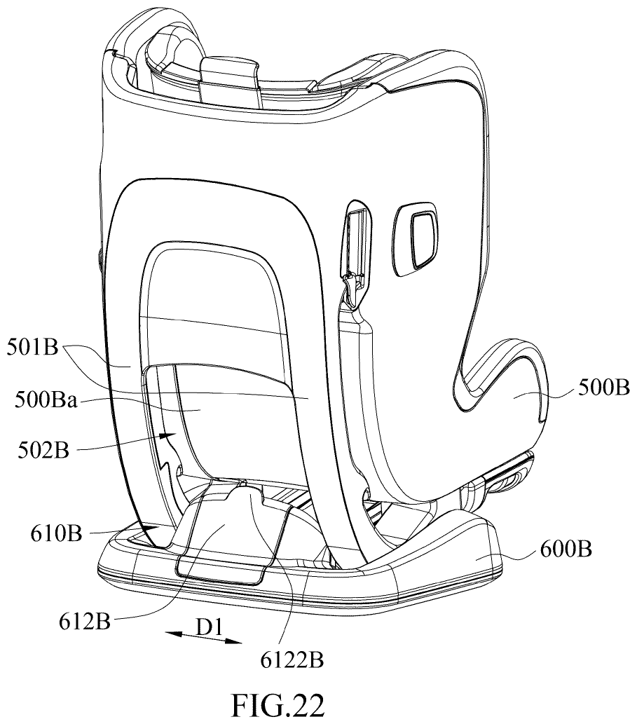

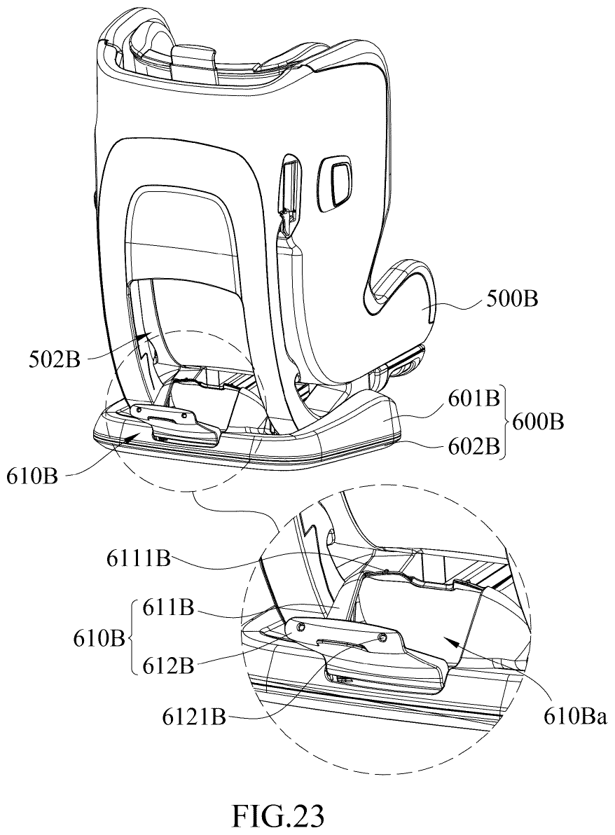

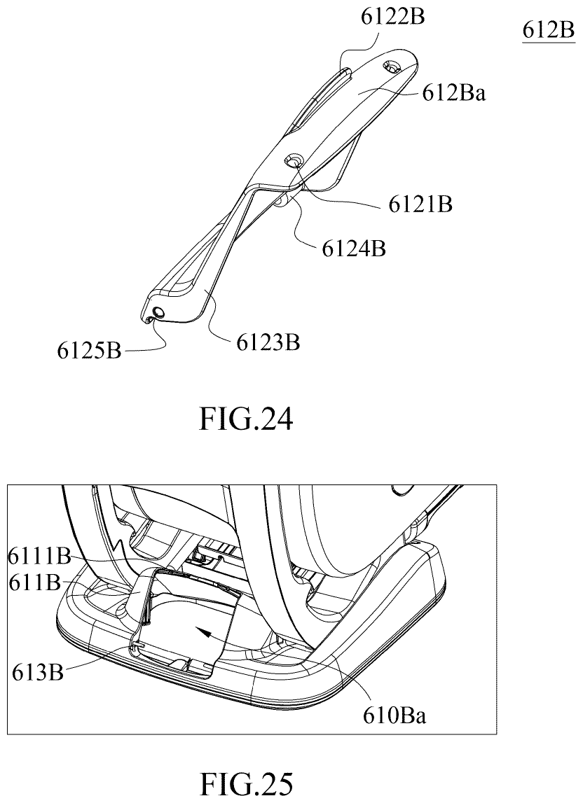

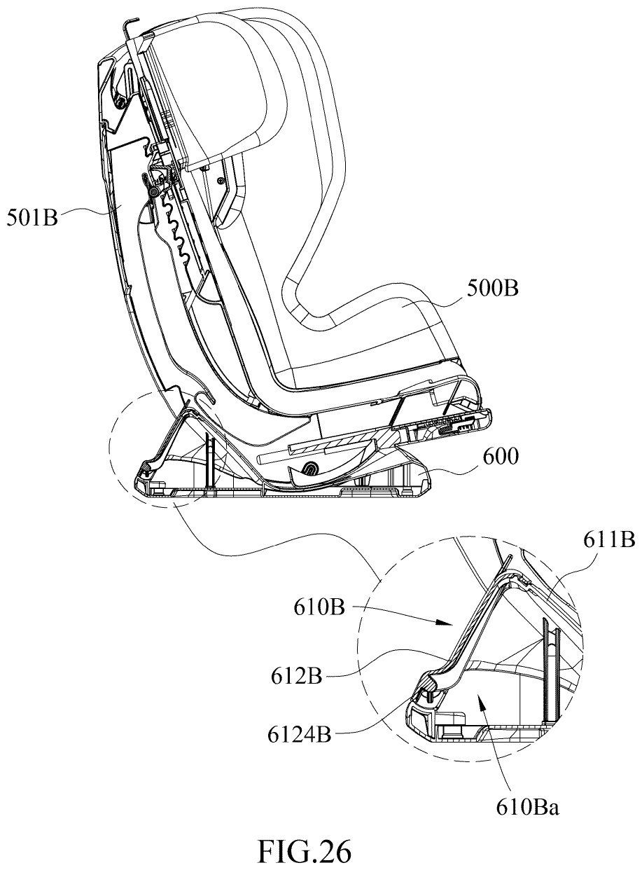

Referring to FIGS. 22 to 26, FIG. 22 shows a perspective view of a child safety seat according to another embodiment of the present disclosure; FIG. 23 shows the storage structure 610B of the child safety seat shown in FIG. 22, in which the cover is opened; FIG. 24 shows a cover 612B of the storage structure 610B shown in FIG. 23; and FIG. 25 shows another perspective view of the child safety seat shown in FIG. 23, in which the cover 612B is removed; and FIG. 26 shows a lateral sectional view of the child safety seat shown in FIG. 23.

As shown in FIG. 22, the child safety seat of the present disclosure may include a seating part 500B and a base 600B below the seating part 500B. In addition, the child safety seat may also be provided with a storage structure 610B for storing some small objects, such as the instruction manuals and/or related small components of the child safety seat.

With reference to FIGS. 22 and 23, the storage structure 610B may be provided at the rear of the base 600B of the child safety seat and positioned below the seating part 500B. The seating part 500B may be provided on the base 600B through a support structure, so that there is an interval distance between the back side (for example, the lower portion of the back side) of the seating part 500B and the base 600B (or an angle formed between at least one portion of the back side of the seating part 500B and the base 600B), to form an avoidance space 502B. The avoidance space 502B is positioned between the support structure, preferably in the middle of the child safety seat in a lateral direction D1. In an example, as shown in FIG. 22, the support structure may include support rods 501B symmetrically provided on both sides of the child safety seat, and the avoidance space 502B is positioned between the support rods 501B on both sides. Optionally, the support structure may be inverted U-shaped, that is, the support rods 501B on both sides may be connected to be a whole through a cross rod above the support rods 501B. Optionally or alternatively, the support structure may be integrally formed with the seating part 500B, for example, the upper end of the inverted U-shaped structure is integrally formed with the seating part 500B.

As shown in FIG. 23, the storage structure 610B may include a shell 611B. The shell 611B is provided on the child safety seat and forms a storage space 610Ba for storing objects. Specifically, the storage structure 610B may be provided to protrude upward from the rear of the base 600B and protrude into the avoidance space 502B. More specifically, the storage structure 610B may be provided in the lateral middle position of the rear of the base 600B, for example, just behind and below the sitting portion 500Ba of the seating part 500B in which the child may sit. In an example, the shell 611B of the storage structure 610B may also be integrally formed with the base 600B. For example, the base 600B may include an upper cover 601B and a lower cover 602B. At least one portion of the upper cover 601B (for example, one portion of its rear part, more specifically, one portion of the rear part in the lateral middle position) extends upward, and forms the storage space 610Ba with the lower cover 602B.

As shown in FIGS. 22 and 23, the storage structure 610B may further include a cover 612B. The cover 612B is pivotally connected with the shell 611B to enclose an opening of the storage space 610Ba. As shown in FIG. 23, a mutually matched engagement structure is provided between the shell 611B and the cover 612B, which includes a first engagement member and a second engagement member. In an embodiment, the shell 611B of the storage structure 610B may be provided with a positioning projection 6111B (used as the first engagement member) for cooperating with a positioning hole 6121B (used as the second engagement member) correspondingly provided on the cover 612B, so that the cover 612B may be kept in a closed state relative to the shell 611B.

With reference to FIGS. 23 and 25, the positioning projection 6111B may be provided near an upper edge of the opening of the shell 611B (i.e., the opening of the storage space 610Ba), for example, at a position where the upper surface of the shell 611B is close to the edge of the opening. Accordingly, as shown in FIG. 24, an upper edge of the cover 612B may form a transition portion 612Ba. The transition portion 612Ba may be shaped to match with the upper surface of the shell 611B (especially near the opening of the shell 611B), and the positioning holes 6121B are provided on the transition portion 612Ba and correspond to the positioning projections 6111B, so that when the cover 612B is closed relative to the shell 611B, the positioning projections 6111B may be engaged with the corresponding positioning holes 6121B (i.e., the positioning projection 6111B is clamped in the positioning hole 6121B), so as to keep the cover 612B closed. In an example, the two positioning projections 6111B are symmetrically provided on the shell 611B, and are respectively engaged with the positioning holes 6121B symmetrically provided on the cover 612B. Of course, the present disclosure is not limited thereto, for example, the positions of the positioning projections 6111B and the positioning holes 6121B may be interchanged, and they have different numbers. In addition, it may be understood that the first engagement member (e.g., the engaging portion 6112A and the positioning projection 6111B) and the second engagement member (e.g., the engagement hook 6122A and the positioning hole 6121B) in the foregoing embodiments of the present disclosure may also adopt other mutually cooperated structures as long as the shell and the cover may be engaged with each other.

In an embodiment, an engagement structure is provided at the shell 611B and a first side of the cover 612B, and a pivot structure is provided at the shell 611B and a second side of the cover 612B opposite to the first side. In this embodiment, as shown in FIG. 23, an engagement structure is provided at a position where the upper side of the cover 612B and a position of the shell 611B corresponding to the upper side of the cover 612B, and a pivot structure is provided at a position where the lower side of the cover 612B of the shell 611B corresponding to the lower side of the cover 612B.

As shown in FIGS. 24 to 26, the lower side of the cover 612B is pivotally connected with the shell 611B, so that the cover 612B of the storage structure 610B may be opened downward, which is convenient for putting in and taking out the objects. Specifically, one of the cover 612B and the shell 611B is provided with a rotating shaft, while the other one of the cover 612B and the shell 611B is provided with a connecting hole, so that pivotal connection of the cover and the shell can be realized through the cooperation of the rotating shaft and the connecting hole. In this embodiment, the rotating shaft may be a connecting pin 613B. In an example, as shown in FIGS. 24 and 25, a connecting hole 6125B may be provided at an end of the cover 612B. Specifically, guide portions 6123B (i.e., guide surfaces extending substantially vertically from the two sides of the cover 612B) are respectively provided on both sides of the cover 612B (in a lateral direction D1), and placed at an inner side of the opening of the shell 611B to guide the cover 612B to close relative to the shell 611B. Connecting posts 6124B are respectively provided on the guide portions 6123B on both sides. The connecting posts 6124B extend inward from the guide portions 6123B and opposite to each other, and a connecting hole 6125B is formed, which the connecting pin 613B correspondingly provided on the shell 611B is inserted into, so that the cover 612B may be pivotally connected with the shell 611B. The present disclosure is not limited thereto, and the positions of the connecting hole 6125B and the connecting pin 613B may also be interchanged, or other pivoting modes may be adopted between the cover 612B and the shell 611B.

In addition, as shown in FIGS. 23 and 26, an opening of the storage space 610Ba is provided obliquely, for example, the opening is inclined upward. That is, when the cover 612B pivotally connected to the lower portion of the shell 611B is closed, the cover 612B forms an acute angle with the base 600B, thereby preventing the cover 612B from being accidentally opened.

Optionally, as shown in FIGS. 22 and 24, the cover 612B may be further provided with an extension portion 6122B extending from the upper side of the cover 612B, so that when the cover 612B is closed relative to the shell 611B, the cover 612B may be conveniently opened by applying a force to the extension portion 6122B outward.

It should be noted that, in the case of non-conflicting structures, one or more of the aforementioned embodiments may be mutually combined or interchanged. For example, the embodiments shown in FIGS. 1 and 2 may also be provided with the storage structure for storing the connecting assembly 2 and/or the strap system 3 and/or the top fastening strap assembly 5; and/or the storage structure 610B of the embodiment shown in FIG. 22 may also be configured to store the LATCH structure, and the shell 611B of the storage structure 610B may also be provided with a notch through which the LATCH structure may pass; and/or the storage structure 610A of the embodiment shown in FIG. 18 may also be configured to store small components and the like, and the present disclosure is not limited thereto.

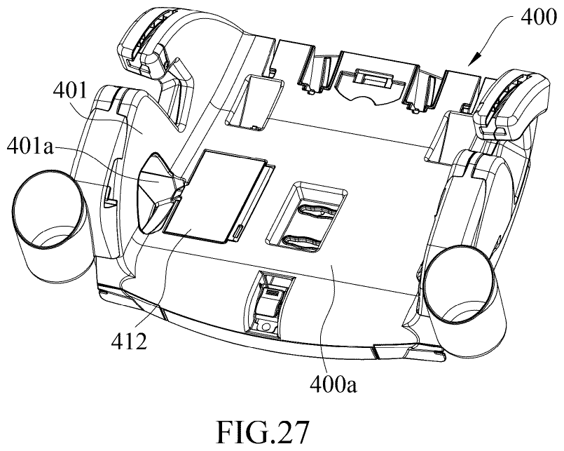

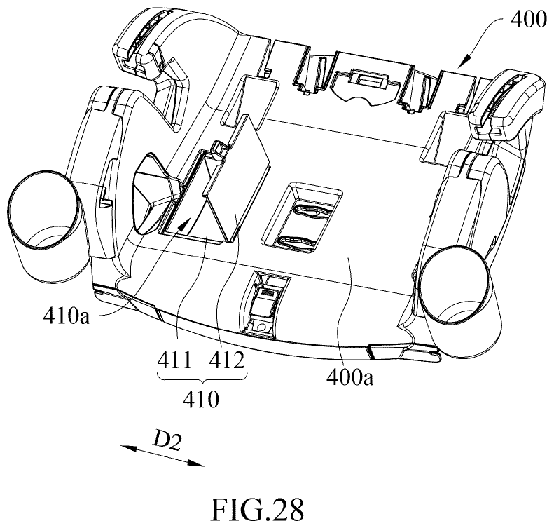

Referring to FIGS. 27 and 28, FIG. 27 shows a perspective view of a seating part 400 of a child safety seat according to another embodiment of the present disclosure, and FIG. 28 shows another perspective view of the seating part 400 shown in FIG. 27, in which a cover of the LATCH storage structure 410 is opened.

As shown in FIGS. 27 and 28, in the child safety seat according to another embodiment of the present disclosure, the seating part 400 includes two armrests 401 that are respectively provided on both sides of a sitting portion 400a in which the child may sit. Each of the two armrests 401 is provided with an avoidance hole 401a at a portion close to the sitting portion 400a, through which the fixing strap 310 of the LATCH structure 300 (not shown) may pass, so that the child safety seat is fixed on the vehicle. In this embodiment, the fixed end 320b of the connecting strap 320 of the LATCH structure 300 is fixed to the sitting portion 400a of the seating part 400 of the child safety seat. In addition, the seating part 400 may also be provided with a storage structure for storing the LATCH structure (in this embodiment, also referred to as the LATCH storage structure 410). Optionally the LATCH storage structure 410 may be provided on a top surface of the seating part 400. For example, as shown in FIG. 27, the LATCH storage structure 410 may be provided at a position of the seating part 400 close to the armrest 401 on either side.

Referring to FIGS. 27 and 28, the LATCH storage structure 410 includes a shell 411, which is provided on the seating part 400 of the child safety seat and forms a storage space 410a for storing the LATCH structure 300 (not shown). For example, as shown in FIG. 28, the shell 411 may be embedded in the seating part 400, and an opening of the storage space 410a is positioned on an upper surface of the sitting portion 400a of the seating part 400. In addition, the LATCH storage structure 410 may further include a cover 412. The cover 412 is pivotally connected with the shell 411 for enclosing the opening of the storage space 410a. In FIG. 28 of the present disclosure, it is shown that a side of the cover 412 in a lateral direction D2 pivots with the shell 411, but the present disclosure is not limited thereto.

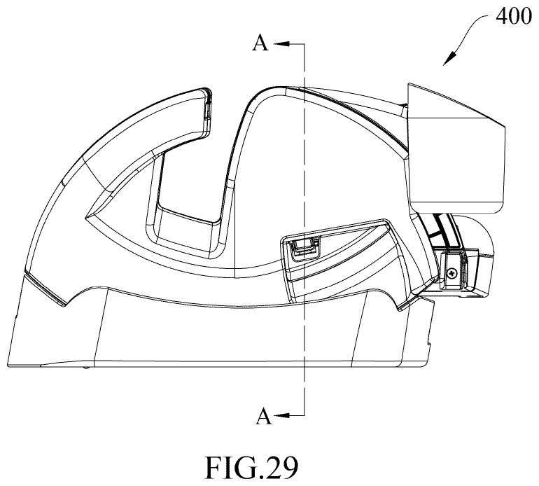

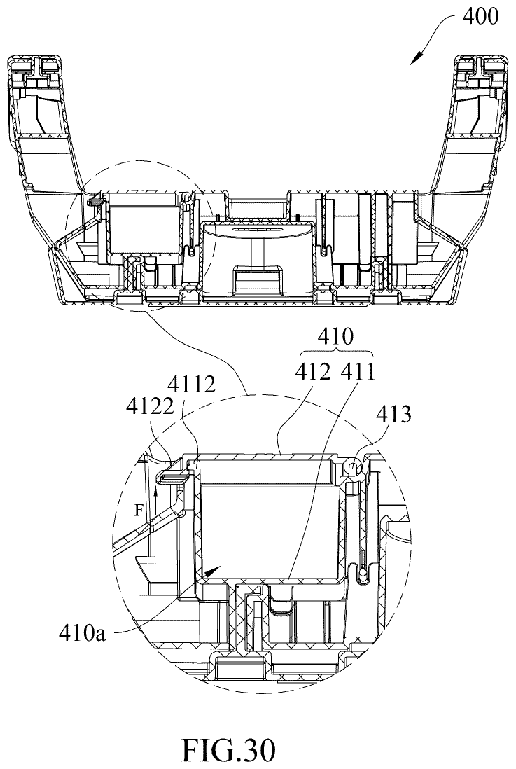

Further referring to FIGS. 29 and 30, FIG. 29 shows a side view of the seating part 400 shown in FIG. 27, and FIG. 30 shows a sectional view taken along a line A-A in FIG. 29.

As shown in FIG. 30, a mutually matched engagement structure is provided between the shell 411 and the cover 412. In this embodiment, the engagement structure includes an engagement hook 4122. The engagement hook 4122 is provided at an edge of the cover 412 and engaged with the engagement part 4112 provided corresponding to the upper side of the end wall of the shell 411. At the edge of the cover 412, a projection extending in a direction opposite to a hook-shaped portion of the engagement hook 4122 is provided to assist in opening the cover 412. When it is necessary to open the cover 412, a force F may be applied on the cover 412 along an arrow direction of FIG. 30 to disengage the engagement hook 4122 from the engagement part 4112 on the shell 411, so as to open the cover 412.

By providing the LATCH storage structure 410 on the child safety seat, when the LATCH structure 300 is not used, the connecting member 330 thereof and most of the straps (for example, the fixing strap 310 and a portion of the connecting strap 320) may be stored in the storage space 410a of the LATCH storage structure 410, so as to allow the appearance of the child safety seat neat. Furthermore, the storage space 410a is sized to just accommodate the connecting member 330 and the straps of the LATCH storage structure 410, so as to avoid generating noise due to the connecting member 330 sliding in the storage space 410a. In addition, the LATCH storage structure 410 of the present disclosure may be provided on the seating part 500A/500B, to improve space utilization ratio of the child safety seat, and not hinder the angle adjustment and slidable loading and unloading of the seating part 500A/500B relative to the base 600A/600B. The storage structure (that is, the LATCH storage structure 410) provided on the seating part 400 of this embodiment may also be used to store other objects, such as the instruction manuals and/or related small components of the child safety seat.

Although relative terms such as “above” and “under” are used herein to describe the relationship of one component relative to another component, such terms are used herein only for the sake of convenience, for example, in the direction shown in the figure, it should be understood that if the referenced device is inversed upside down, a component described as “above” will become a component described as “under”. Other relative terms, such as “top”, “bottom”, “left”, “right” etc., also have similar meanings. When a structure is described as “above” another structure, it probably means that the structure is integrally formed on another structure, or, the structure is “directly” disposed on another structure, or, the structure is “indirectly” disposed on another structure through an additional structure.

In this specification, Words such as “one”, “an/a”, “the” and “said” are used herein to indicate the presence of one or more elements/component parts/and others. Terms “including”, and “having” have an inclusive meaning which means that there may be additional elements/component parts/and others in addition to the listed elements/component parts/and others. Terms “first”, “second” and “third” are used herein only as markers, and they do not limit the number of objects modified after them.

Unless otherwise defined, all terms (including technical and scientific terms) used herein have the same meaning as commonly understood by one of ordinary skill in the art to which the present disclosure belongs. It will be further understood that terms, such as those defined in commonly used dictionaries, may be interpreted as having a meaning that is consistent with their meaning in the context of the relevant art and will not be interpreted in an idealized or overly formal sense unless expressly so defined herein.

It will be apparent that, although the preferred embodiments have been shown and described above, the invention is not limited to the above-described specific embodiments, and various variants and variations can be made by those skilled in the art without departing from the gist of the appended claims. Thus, it is intended that the variants and variations should not be understood independently of the technical sprit or prospect of the invention.

1. A child safety seat, comprising:
a seat shell provided with a connecting through hole on an outer side surface of the seat shell; and
a connecting assembly comprising a connecting strap and a plug; the connecting strap having a first end that is limited after entering an internal space surrounded by the outer side surface of the seat shell through the connecting through hole, and a second end that is connected with the plug for detachably connecting with a receptacle of a vehicle seat.

2. The child safety seat according to claim 1, wherein
the seat shell comprises a seat part and a backrest part;
the child safety seat further comprises a shoulder strap, and the shoulder strap has a first end attached to the seat part and a second end extending backward from the backrest part;
the connecting strap is connected with the shoulder strap, and a position where the connecting strap is connected with the shoulder strap is close to the first end of the shoulder strap.

3. The child safety seat according to claim 2, wherein the seat part is provided with a first hole, and at least one of the first end of the shoulder strap and the first end of the connecting strap passes through the first hole and is connected with a first stopper, and the shoulder strap and the connecting strap are connected through the first stopper.

4. The child safety seat according to claim 3, wherein when the shoulder strap and the connecting strap are tensioned, the shoulder strap and the connecting strap apply pulling forces in opposite directions to the first stopper.

5. The child safety seat according to claim 3, wherein
the seat part is also provided with a second hole and a third hole; the first hole is positioned between the second hole and the third hole; and the second hole is closer to a longitudinal center plane of the seat shell than the third hole;
the first end of the connecting strap passes through the third hole and the first hole in turn, and is connected with the first stopper, and the first stopper is positioned above the first hole;
the first end of the shoulder strap passes through the first hole and the second hole in turn, and is connected with a second stopper, and the second stopper is positioned above the second hole; and
the shoulder strap is connected with the first stopper.

6. The child safety seat according to claim 3, wherein
the seat part is further provided with a fourth hole, and the fourth hole is closer to a longitudinal center plane of the seat shell than the first hole;
the first end of the shoulder strap passes through the fourth hole and the first hole in turn, and is connected with the first stopper, and the first stopper is positioned above the first hole;
the first end of the connecting strap is connected with the first stopper.

7. The child safety seat according to claim 3, wherein
the seat part is further provided with a fifth hole, and the fifth hole is closer to a longitudinal center plane of the seat shell than the first hole;
the first stopper is positioned below the first hole and the fifth hole, the first end of the connecting strap passes through the first hole and is connected with the first stopper, and the shoulder strap passes through the fifth hole and is connected with the first stopper.

8. The child safety seat according to claim 3, wherein the first stopper is positioned below the first hole, and both the first end of the shoulder strap and the first end of the connecting strap pass through the first hole, and are connected with the first stopper.

9. The child safety seat according to claim 2, wherein
the seat part is provided with a first hole, a second hole and a third hole; the third hole is positioned between the first hole and the second hole, and the second hole is closer to a longitudinal center plane of the seat shell than the first hole;
the first end of the connecting strap passes through the third hole and the first hole in turn, and is connected with a first stopper, and the first stopper is positioned above the first hole;
the first end of the shoulder strap passes through the third hole and the second hole in turn, and is connected with a second stopper, and the second stopper is positioned above the second hole.

10. The child safety seat according to claim 1, wherein
a positioning part is provided at the outer side surface of the seat shell, and the plug is suitable for being connected with the positioning part; and/or
the child safety seat further comprises a top fastening strap assembly, and the top fastening strap assembly comprises two first fastening straps extending from left and right sides of the outer side surface of the seat shell, and a second fastening strap connected with the two first fastening straps, and an anchor is provided at an end of the second fastening strap.

11. The child safety seat according to claim 10, wherein
the positioning part comprises a support seat and a rod, the support seat protrudes from the outer side surface of the seat shell, two ends of the rod are connected with the support seat, and the plug is suitable for hooking onto the rod; or
the positioning part comprises a rib plate extending from the outer side surface of the seat shell, and the rib plate is provided with a perforation, and the plug is hooked onto the rib plate through the perforation.

12. The child safety seat according to claim 2, wherein the connecting strap is directly connected with the shoulder strap.

13-37. (canceled)

38. The child safety seat according to claim 3, wherein a size of the first stopper is larger than a size of the first hole, and the first stopper abuts against an edge of the first hole.

39. The child safety seat according to claim 5, wherein a size of the second stopper is larger than a size of the second hole, and the second stopper abuts against an edge of the second hole.

40. The child safety seat according to claim 5, wherein the seat part is further provided with a groove for positioning the second stopper, and/or the seat part is provided with a groove for positioning the first stopper.

41. The child safety seat according to claim 1, wherein the outer side surface of the seat shell is provided with a positioning part,
when the connecting assembly is in a non-use state, the plug is suitable to connect with the positioning part to be positioned.

42. The child safety seat according to claim 41, wherein the positioning part comprises a support seat and a rod, the support seat is provided on the outer side surface of the seat shell, both ends of the rod are connected with the support seat, and the plug is suitable to be hooked on the rod.

43. The child safety seat according to claim 41, wherein two positioning parts are arranged on the outer side surface of the seat shell, the two positioning parts are symmetrically arranged with respect to a longitudinal center plane of the seat shell, and the two positioning parts correspond to the plugs of the connecting assemblies on both sides of the seat shell one by one.

44. The child safety seat according to claim 5, wherein the first hole, the second hole and the third hole are provided side by side and close to the backrest part.

45. The child safety seat according to claim 1, wherein
the child safety seat further comprises a top fastening strap assembly, and the top fastening strap assembly comprises two first fastening straps and one second fastening strap,
first ends of the two first fastening straps are respectively connected to left and right sides of the outer side surface of the seat shell, and second ends of the two first fastening straps are connected with the first ends of the second fastening straps after passing over the vehicle seat, and a second end of the second fastening strap is provided with an anchor for connecting with an anchoring point inside the vehicle seat.
